(19) United States
(12) Patent Application Publication
(10) Pub. No.: US 2004/0208563 A1
(43) Pub. Date: Oct. 21, 2004

(54) Ranging in the physical layer

(76) Inventors: Harold A. Roberts, Prior Lake, MN (US); Paul E. Nikolich, Lynnfield, MA (US)

Correspondence Address: FOGG AND ASSOCIATES, LLC, P.O. BOX 581339, MINNEAPOLIS, MN, 55458-1339, US

(21) Appl. No.: 10/210,523

(22) Filed: Aug. 1, 2002

(51) Int. Cl. H04B 10/08; H04B 10/00

(52) U.S. Cl. 398/70

(57) ABSTRACT

A method for ranging a plurality of remote modules at the physical layer is provided. The method includes transmitting a signal under control of the physical layer from a head end to a plurality of remote modules indicating the beginning of a ranging period and receiving ranging signals from each remote module during a specified time slot for the remote module generated under control of the physical layer.

### TECHNICAL FIELD

The present invention relates generally to the field of telecommunications and, in particular, to ranging in the physical layer.

### BACKGROUND

Telecommunication networks transport data, e.g., voice, video, or other data, between user equipment at various locations. To accomplish this, telecommunication networks include a variety of electronic modules, such as switches, transmitters, receivers, amplifiers, line cards, etc., that work together to carry data to the user equipment. Often, electronic modules in the network are separated by a significant distance. The distance between modules affects the timing of signals transmitted between modules. Thus, many telecommunication systems include circuitry that adjusts the timing of signals to account for the distance between modules. At selected times, the system monitors the timing of signals transported over these links. This is referred to as “ranging.”

Ranging can be complicated when multiple communication modules sharing the same link attempt to range to a single modem or head end at the same time. This often results in collisions between signals from the various communication modules. When this occurs, each communication module typically backs off a selected period of time and attempts again to range. Ranging following a service disruption, e.g., a cable cut, or initial ranging can be a time consuming process with a large number of modules attempting to range at the same time due to many iterations of collisions and back-offs. In addition, the development of standards is hindered when ranging requires complex interactions utilizing the MAC (media access control) layer.

For the reasons stated above, and for other reasons stated below which will become apparent to those skilled in the art upon reading and understanding the present specification, there is a need in the art for a technique for improving ranging of remote devices after a service interruption, fiber protection switch, as well as initial ranging.

### SUMMARY

The above-mentioned problems with ranging and other problems are addressed by embodiments of the present invention and will be understood by reading and studying the following specification. Specifically, embodiments of the present invention provide for ranging of electronic modules at the physical layer. In one embodiment, the elements of the ranging process are hard coded into the circuitry of the electronic modules such that each module attempting to range is assigned a selected, static ranging time slot. Each electronic module knows its assigned slot. Thus, after a service interruption or at any other appropriate time, all of the electronic modules are guaranteed to be re-ranged in a single pass through the ranging time slots.

In one embodiment, a method for ranging a plurality of remote modules at the physical layer is provided. The method includes transmitting a signal under control of the physical layer from a head end to a plurality of modems indicating the beginning of a ranging period and receiving ranging signals from each modem during a specified time slot for the modem generated under control of the physical layer.

### BRIEF DESCRIPTION OF THE DRAWINGS

FIG. 1 is a block diagram of one embodiment of a network according to the teachings of the present invention.

FIG. 2 is a flow chart of one embodiment of a process for ranging a remote module according to the teachings of the present invention.

FIG. 3 is a flow chart of one embodiment of a process for a head end for ranging a plurality of remote modules according to the teachings of the present invention.

FIG. 4 is a flow chart of one embodiment of a process for a remote module to range according to the teachings of the present invention.

FIG. 5 is a flow chart of another embodiment of a process for a remote module to range according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention address problems with ranging of electronic modules in communication systems. The embodiments described below provide ranging of electronic modules at the physical layer. This is accomplished by assigning each module a selected time slot in a ranging interval for ranging purposes. The modules are ranged in turn, in a single pass. Each module is ranged during its assigned time slot. Although the embodiment below is described in terms of a passive optical network, the teachings of the present invention are not limited to optical networks. Rather, the teachings of the present invention are applicable to other types of communication networks, e.g., hybrid fiber/coax, coax, wireless and other appropriate communication networks that use ranging of electronic modules.

In one embodiment, ranging in the physical layer is accomplished in a passive optical network between a head end and up to 128 modems. In this embodiment, the ranging interval for 128 modems is approximately 12.8 to 25.6 milliseconds. The ranging interval includes 128 time slots (one per modem) of approximately 100 to 200 microseconds each. The duration of the time slots is based on a maximum allowable distance between the head end and any given modem. As the maximum allowable distance is increased, the duration of the time slots and the ranging interval also increase. For example, the 100 microsecond time slots relate to a 10 Kilometer maximum range. If the maximum range is increased to 20 Kilometers, then the time interval doubles. The ranging interval of this embodiment may be configured to use less than 1 percent of the available bandwidth in the network. Further, with the time between ranging intervals of 12.8 to 25.6 milliseconds, the total time to recover from a catastrophic fiber protection switch (resulting in a transport delay change) is on the order of 1.28 to 2.56 seconds. If the system switches to a fast ranging mode upon detection of failure or delay change, the ranging can consume 100% of the bandwidth and the total ranging time is reduced to 12.8 to 25.6 ms.

### I. Network with Ranging in the Physical Layer

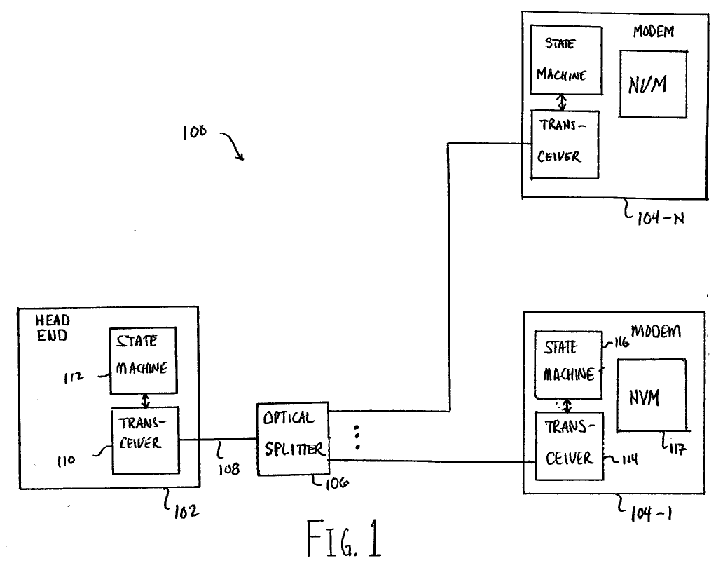

FIG. 1 is a block diagram of one embodiment of a network, indicated generally at 100, according to the teachings of the present invention. Advantageously, network 100 determines timing and other parameters for remote modules 104-1 to 104-N, e.g., a plurality of modems, using a procedure implemented in the physical layer so that the remote modules can be re-ranged, in turn, during a single pass, e.g., following a service interruption or fiber protection switch. Network 100 includes head-end 102 that communicates with a plurality of remote modules 104-1 to 104-N over a distribution network. In one embodiment, head end 102 communicates with up to 128 modems.

In one embodiment, network 100 is a passive optical network although the principle of ranging at the physical layer can be applied in other network topologies and network types. Network 100 includes a plurality of optical splitters represented by optical splitter 106. Optical splitter 106 is coupled to head end 102 over optical path 108, e.g., an optical fiber. Optical splitter 106 is shown in a star configuration. It is understood that in other embodiments a bus or other appropriate configuration is used. Optical splitter 106 is also coupled to a plurality of remote modules, including remote module 104-1.

A. The Head End

Head end 102 determines when to initiate a ranging process for the remote modules 164-1 to 104-N of network 100. Advantageously, head end 102 ranges the remote modules 104-1 to 104-N in the physical layer thus avoiding complexities in implementing a higher level approach to ranging, e.g., making changes to the Media Access Control (MAC) layer.

Head end 102 includes transceiver 110 and state machine 112 that are used to implement this physical layer ranging process. Transceiver 110 transmits downstream signals to and receives upstream signals from remote modules 104-1 to 104-N. State machine 112 controls the ranging process at the physical layer.

State machine 112 initiates a ranging operation for remote modules 104-1 to 104-N. Each remote module 104-1 to 104-N has a static time slot in a ranging period or interval during which it is allowed to send ranging signals to head end 112. In one embodiment, the ranging interval is a period of time sufficient to allow each remote module to transmit a round trip signal at the maximum distance in the network. Each time slot is similarly equal to the time for a signal to travel the maximum roundtrip distance in the network. All of the remote modules 104-1 to 104-N are ranged in a single pass by ranging each remote module in its assigned time slot as initiated by state machine 112.

In one embodiment, the assignment of a time slot for each modem is controlled by higher layer software in head end 102. In one embodiment, state machine 112 incorporates a list of used time slots in the message initiating a ranging interval. In one embodiment, this list provides a map between the remote modules and the assigned time slots. The map is transmitted to the modems periodically from the head end. Any remote module without a time slot is allowed to select the next time slot at the end of the ranging interval. Alternatively, in another embodiment, state machine 112 includes a list of all available time slots in the message initiating a ranging interval. Each remote module without an assigned time slot is free to select any of the available slots in the interval. Since it is unlikely that multiple remote modules would be added to network 100 at the same instant in time, it is unlikely that two remote modules would attempt to use the same slot. If, however, two or more remote modules were to attempt to use the same slot, a back-off algorithm is used to allow each remote module to be assigned a separate slot.

When a remote module is removed from the system, state machine 112 is allowed to re-assign its time slot to another remote module. In one embodiment, if a remote module re-joins a network, the remote module waits for an indication from state machine 112 that the former time slot is either still assigned to the remote module or is available before using the time slot during a ranging interval. In one embodiment, this is accomplished by comparing a time slot assignment indicated in a downstream message with a stored prior time slot value.

State machine 112 determines ranging parameters for the remote modules 104-1 to 104-M. In one embodiment, these parameters include power level, frequency, timing, equalizer coefficients and the like. In another embodiment, state machine 112 determines parameters such as timing and power levels for optical “1” and optical “0.” For hybrid fiber/coax and wireless networks, other parameters such as carrier frequency and channel distortions are also compensated for.

B. Remote Modules

Remote modules 104-1 to 104-N respond to a command from head end 112 to initiate a ranging process. In one embodiment, remote modules 104-1 to 104-N are modems that communicate with head end 112 over a passive optical network. Remote modules 104-1 to 104-N each include similar components for ranging at the physical layer. For simplicity, only remote module 104-1 is described in detail.

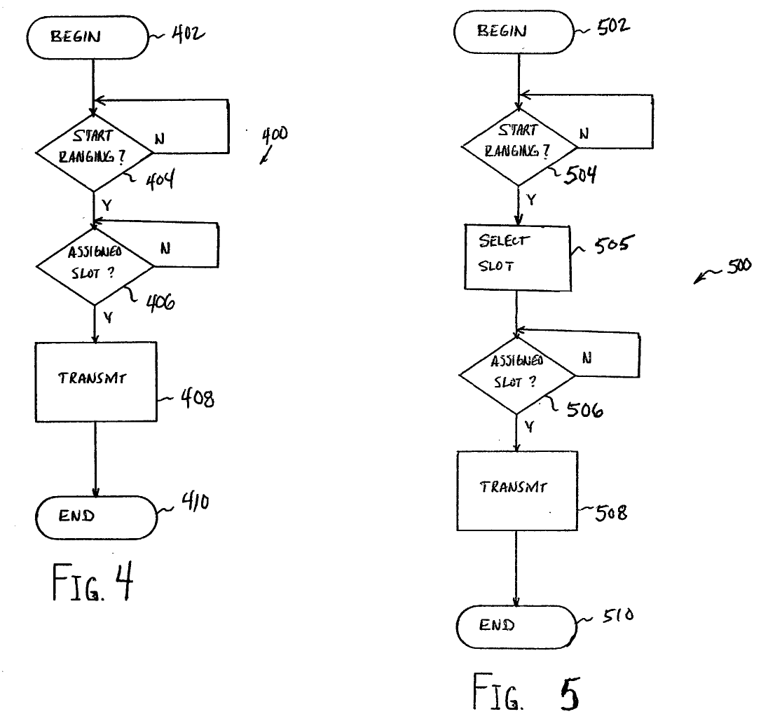

Remote module 104-1 includes transceiver 114, state machine 116 and non-volatile memory (NVM) 117 that implement the ranging process. Transceiver 114 transmits upstream signals to and receives down stream signals from head end 102. State machine 116 implements the ranging process for remote module 114-1. In one embodiment, state machine 116 implements the process described below with respect to FIGS. 4 and 5. NVM 117 stores the assigned, static time slot used by remote module 104-1 during the ranging process. In one embodiment, remote module 104-1 selects the static time slot based on information provided by the head end 102 as described above.

State machine 116 receives a command from the head end 102 at the physical layer to initiate the ranging process. When initiated, state machine 116 waits until the assigned time slot and transmits a ranging signal. In one embodiment, the ranging signal includes a preamble, a MAC address, and other information that is specific to the remote module. This signal is received at the head end and ranging parameters for the modem are determined.

C. Operation of Ranging in the Physical Layer

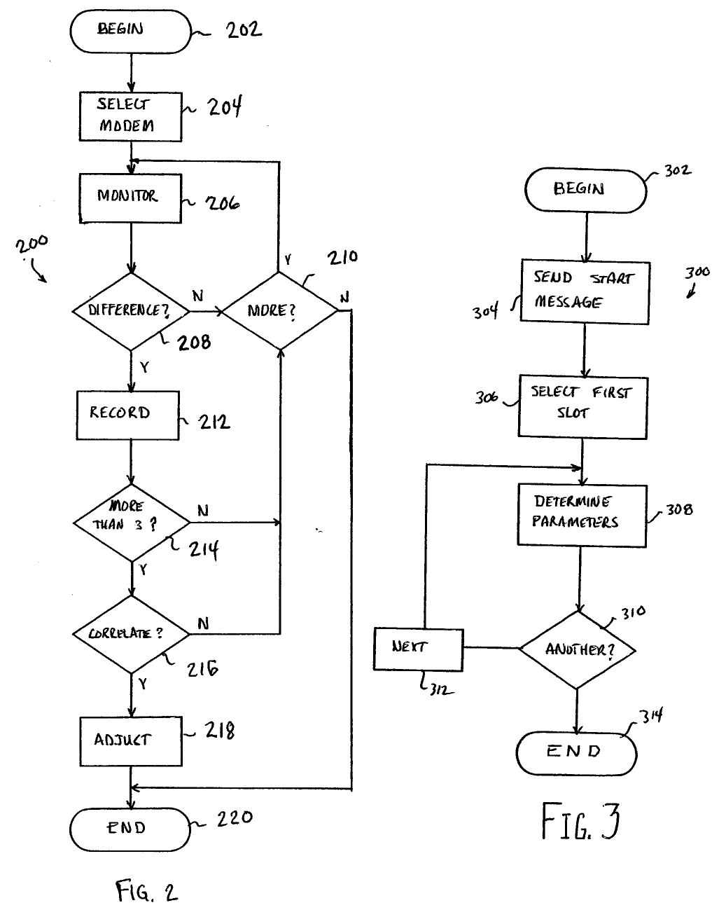

FIG. 3 is a flow chart of one embodiment of a process, indicated generally at 300, for a head end for ranging a plurality of remote modules, e.g., modems, according to the teachings of the present invention. The method begins at block 302. At block 304, the method determines that a ranging process is to begin. For example, the method determines that a system failure has been fixed and that the remote modules need to be re-ranged. Alternatively, a ranging interval is initiated without a system failure, such as initial ranging.

Method 300 transmits a message to the remote modules that a ranging interval is about to begin. In one embodiment, this message also includes an indication of unused ranging slot(s) that can be used by remote modules that have recently been attached to the network, but not registered. The unused ranging slot(s) can be at the end of the ranging interval or spread throughout. In another embodiment, this message includes a map between the remote modules and the assigned slots.

At block 306, the method selects a first time slot associated with a first remote module to be ranged. At block 308, method 300 determines ranging parameters, e.g., round trip delay, for the remote module. At block 310, method 300 determines whether the method has processed all time slots (e.g., all remote modules have been processed). If there are more remote modules, method 300 moves to the next time slot at block 312 and returns to block 308. If not, method 300 proceeds to end at block 314.

FIG. 4 is a flow chart of one embodiment of a process, indicated generally at 400, for ranging at a remote module according to the teachings of the present invention. The method begins at 402. At block 404, the method determines whether the head end has indicated to start a ranging interval. If not, the method returns to block 404.

When a ranging interval starts, the method proceeds to block 406. At block 406, the method determines whether the current time slot is a time slot assigned to the remote module. In one embodiment, the method determines whether the slot is assigned based on the time since the beginning of a ranging interval. Further, the remote module determines the appropriate time to wait based on data stored in its non-volatile memory. If the time slot has not arrived, the method returns to block 406.

When the time slot for the remote module arrives, the method proceeds to block 408 and transmits a ranging signal to the head end. The method ends at block 410. Advantageously, by assigning a static time slot to each remote module in a ranging interval, the process allows all remote modules in a network to be ranged in a single pass through the ranging interval without the need for slow and indeterminate collision detection and back-off algorithms. Thus, all remote modules in a network, e.g., up to 128 modems, can be completely re-ranged in as little at 12.8 milliseconds (e.g., 128 times a maximum round trip delay for signals traveling up to 10 Km).

Although the process described above is designed to avoid collisions in the ranging modules in a communication system, a mechanism is provided in the event of unexpected collisions. In one embodiment, this includes a conventional back off algorithm in which each module backs off a random amount of time and retries to range.

FIG. 5 is a flow chart of another embodiment of a process, indicated generally at 500, for ranging at a remote module according to the teachings of the present invention. This process is similar to the process of FIG. 4 but adds the selection of a time slot by a remote module that previously did not have a time slot for ranging purposes.

The method begins at 502. At block 504, the method determines whether the head end has indicated to start a ranging interval. If not, the method returns to block 504.

When a ranging interval starts, the method proceeds to block 505. At block 505, the method selects a ranging slot if one is not currently available in the remote modules non-volatile memory, e.g., a ranging slot has not been previously assigned or a previously assigned ranging slot has been lost from non-volatile memory. The method proceeds to block 506.

At block 506, the method determines whether the current time slot is a time slot assigned to the remote module. In one embodiment, the method determines whether the slot is assigned based on the time since the beginning of a ranging interval. Further, the remote module determines the appropriate time to wait based on data stored in its non-volatile memory. If time slot has not arrived, the method returns to block 506.

When the time slot for the remote module arrives, the method proceeds to block 508 and transmits a ranging signal to the head end. The method ends at block 510. Advantageously, by assigning a static time slot to each remote module in a ranging interval, the process allows all remote modules in a network to be ranged in a single pass through the ranging interval without the need for complicated collision detection and back-off algorithms. Thus, all remote modules in a network, e.g., up to 128 modems, can be completely re-ranged following a system failure in a single pass in approximately 12.8 to 25.6 milliseconds (e.g., 128 times a maximum round trip delay for signals traveling between 10 to 20 Km) as long as the system bandwidth is dedicated to ranging opportunities after a failure.

### II. Alternative Processes for Ranging at the Physical Layer

FIG. 2 is a flow chart of another embodiment of a process, indicated generally at 200, for ranging electronic modules according to the teachings of the present invention. In one embodiment, method 200 monitors a plurality of remote modules to determine, unambiguously, whether changes in timing have occurred at a level sufficient to require re-ranging of the remote modules. For example, method 200 determines when timing has changed enough due to, e.g., a fiber protection switch or a fiber cut, to require ranging for the remote modules. If so, method 200 captures the magnitude of the change using remote modules in an audit. Finally, method 200 determines and implements a mass change for all remote modules when necessary. This is an alternative to using the assigned time slot approach described above with respect to FIGS. 1, 3-5. Again, this process may be accomplished in the physical layer.

Method 200 begins at block 202. At block 204, method 200 selects a remote module to monitor. Method 200 proceeds to monitor the selected remote module at block 206. At block 208, method 200 determines whether the timing of signals for the remote module has changed sufficiently, e.g., whether the timing change exceeds a threshold. In one embodiment, method 200 monitors a round-trip delay for signals between the head end and the remote module. If the change in this timing is not significant, method 200 proceeds to block 210 and determines whether there are more remote modules to be monitored. If so, method 200 returns to block 206. If not, method 200 ends at block 220.

If the timing has changed significantly, method 200 proceeds to block 212 and records the change in timing for the remote module. At block 214, method 200 determines whether a sufficient number, e.g., more than three, of the monitored remote modules have experienced a significant change in timing. If not, method 200 proceeds to block 210. If, however, method 200 determines that more than three of the remote modules have experienced significant changes in timing, the method further proceeds to block 216. At block 216, method 200 determines whether the changes in timing for the remote modules correlate (are close enough in magnitude and direction to be the result of a universal delay and/or power change). If not, the method also returns to block 210. If, however, method 200 determines that the measured differences in timing correlate, the method proceeds to block 218 to initiate a ranging adjustment.

In one embodiment, method 200 implements the method of FIG. 3 to adjust the ranging for the remote modules. In another embodiment, method 200 uses the recorded changes in timing to generate a timing adjustment for all remote modules. This timing adjustment is broadcast to all of the remote modules in order to bring the remote modules back into proper timing alignment. Method 200 ends at block 220.

Although specific embodiments have been illustrated and described herein, it will be appreciated by those of ordinary skill in the art that any arrangement, which is calculated to achieve the same purpose, may be substituted for the specific embodiments shown. For example, in other embodiments, any appropriate number of modems is accounted for in the ranging process. Further, other embodiments of a network implementing ranging in the physical layer include a passive optical network with a bus configuration between the head end and the remote modules. Further, in other embodiments, ranging at the physical layer is applied in other appropriate communications networks, e.g., hybrid fiber/coax, coax, wireless and any other appropriate networks. This application is intended to cover any adaptations or variations of the present invention. Therefore, it is intended that this invention be limited only by the claims and the equivalents thereof.

What is claimed is:

1. A passive optical network, comprising:
a head end including a transceiver and a state machine;
at least one optical splitter, coupled to the head end over an optical fiber; and
a plurality of remote modules, each including a transceiver, non-volatile memory and a state machine, each remote module coupled to the at least one optical splitter; and
wherein the head end state machine initiates a ranging process through the head end transceiver and the state machine, each remote module provides a ranging signal to the head end through the remote module transceiver during an assigned ranging time slot stored in the non-volatile memory to provide ranging of the remote modules at the physical layer.

2. The network of claim 1, wherein the plurality of remote modules comprises up to 128 modems.

3. The network of claim 1, wherein the head end is coupled to the remote modules in one of a bus and a star configuration.

4. The network of claim 1, wherein the state machine in the remote module comprises a state machine that selects the ranging time slot for the remote module.

5. The network of claim 1, wherein the ranging time slot for each remote module is static once selected.

6. A method for ranging a plurality of remote modules at the physical layer, the method comprising:
transmitting a signal under control of the physical layer from a head end to a plurality of remote modules indicating the beginning of a ranging period; and
receiving ranging signals from each remote module during a specified time slot for the remote module generated under control of the physical layer.

7. The method of claim 6, wherein receiving the ranging signals comprises receiving ranging signals during time intervals that are established to be at least as long as the maximum expected round trip delay.

8. The method of claim 6, wherein receiving the ranging signals comprises receiving the ranging signals in a sequential order based on time slots assigned to or selected by each remote module.

9. The method of claim 8, wherein the time slots are static once assigned to a remote module.

10. The method of claim 6, and further comprising determining ranging parameters for each remote module.

11. The method of claim 6, wherein transmitting a signal under control of the physical layer from a head end to a plurality of remote modules includes transmitting a signal that identifies available time slots.

12. A method for ranging a plurality of remote modules at the physical layer, the method comprising:
determining when to initiate ranging of the plurality of remote modules;
transmitting a signal under control of the physical layer from a head end to a plurality of remote modules indicating initiation of a ranging period; and
receiving ranging signals from each remote module during a specified time slot for the remote module generated under control of the physical layer.

13. The method of claim 12, wherein determining when to initiate ranging of the plurality of remote modules comprises:
monitoring the plurality of remote modules;
determining when a select number of the remote modules have experienced changes in timing;
determining when the changes in timing are correlated; and
when the select number of remote modules experience a correlated change in timing, initiating ranging of the plurality of remote modules.

14. The method of claim 12, wherein receiving the ranging signals comprises receiving ranging signals during time intervals that are established to be at least as long as the maximum expected round trip delay.

15. The method of claim 12, wherein receiving the ranging signals comprises receiving the ranging signals in a sequential order based on time slots assigned to each remote module.

16. The method of claim 15, wherein the time slots are static once assigned to a remote module.

17. The method of claim 12, and further comprising determining ranging parameters for each remote module.

18. The method of claim 12, wherein transmitting a signal under control of the physical layer from a head end to a plurality of remote modules includes transmitting a signal that identifies available time slots.

19. A method for correcting timing of a plurality of remote modules, the method comprising:
monitoring the plurality of remote modules;
determining when a select number of the remote modules have experienced changes in timing;
determining when the changes in timing are correlated; and
when the select number of remote modules experience a correlated change in timing, adjusting the timing of the remote modules.

20. The method of claim 19, wherein adjusting the timing comprises transmitting an adjustment command to all remote modules.

21. The method of claim 19, wherein adjusting the timing comprises:
transmitting a signal under control of the physical layer from a head end to a plurality of remote modules indicating initiation of a ranging period; and
receiving ranging signals from each remote module during a specified time slot for the remote module generated under control of the physical layer.

22. The method of claim 21, and further comprising determining ranging parameters for each remote module.

23. A method for ranging at a remote module in a communication system, the method comprising:
receiving a signal indicating the initiation of a ranging interval;
retrieving a value from memory indicating an assigned ranging time slot;
waiting for the assigned ranging time slot; and
transmitting ranging signals at the physical layer during the assigned time slot.

24. The method of claim 23, wherein receiving a signal indicating the initiation of a ranging interval comprises receiving a signal that indicates at least one available ranging time slot.

25. The method of claim 24, and further comprising selecting a ranging time slot indicated in the signal indicating the initiation of the ranging interval.

26. A communication network, comprising:
a head end including a transceiver and a state machine;
a distribution network coupled to the head end; and
a plurality of remote modules coupled to the distribution network, each including a transceiver, non-volatile memory and a state machine; and
wherein the head end state machine initiates a ranging process through the head end transceiver and the state machine, each remote module provides a ranging signal to the head end through the remote module transceiver during an assigned ranging time slot stored in the non-volatile memory to provide ranging of the remote modules at the physical layer.

27. The network of claim 1, wherein the plurality of remote modules comprises a plurality of modems.

28. The network of claim 1, wherein the head end is coupled to the remote modules in one of a bus and a star configuration.

29. The network of claim 1, wherein the state machine in the remote module comprises a state machine that selects the ranging time slot for the remote module.

30. The network of claim 1, wherein the ranging time slot for each remote module is static once assigned.

31. A communication network, comprising:
a head end including a transceiver and a state machine;
a distribution network coupled to the head end, the distribution network adapted to provided access for a plurality of remote modules; and
wherein the head end state machine initiates a ranging process at the physical layer at selected times through the head end transceiver and the state machine, the ranging process providing an assigned ranging time slot for each of the plurality of remote modules associated with the communication network.
